(19) United States
(12) Patent Application Publication
(10) Pub. No.: US 2018/0105946 A1
(43) Pub. Date: Apr. 19, 2018

(54) COPPER OXIDE POWDER FOR USE IN PLATING OF A SUBSTRATE, METHOD OF PLATING A SUBSTRATE USING THE COPPER OXIDE POWDER, AND METHOD OF MANAGING PLATING SOLUTION USING THE COPPER OXIDE POWDER

(71) Applicant: EBARA CORPORATION, Tokyo (JP)

(72) Inventors: Masashi SHIMOYAMA, Tokyo (JP); Jumpei FUJIKATA, Tokyo (JP); Fumitoshi NISHIURA, Tokyo (JP); Takashi KISHI, Tokyo (JP)

(21) Appl. No.: 15/728,175

(22) Filed: Oct. 9, 2017

(30) Foreign Application Priority Data
Oct. 14, 2016 (JP) 2016-202545

(51) Int. Cl. C25D 3/28; C25D 17/02; C25D 17/10; C25D 21/12; C01G 3/02

(52) U.S. Cl. CPC C25D 3/28; C25D 17/02; C01P 2004/61; C25D 21/12; C01G 3/02; C25D 17/10

(57) ABSTRACT

Soluble copper oxide powder capable of preventing a decrease in quality of a copper film formed by plating is disclosed. The copper oxide powder contains copper and impurities including sodium. A concentration of the sodium is not more than 20 ppm. The copper oxide powder is regularly supplied into a plating solution. A voltage is applied between an insoluble anode and a substrate immersed in the plating solution, thereby plating the substrate.

### CROSS REFERENCE TO RELATED APPLICATION

This document claims priority to Japanese Patent Application No. 2016-202545 filed Oct. 14, 2016, the entire contents of which are hereby incorporated by reference.

### BACKGROUND

As electronics are becoming smaller in size, higher speed, and less power consumption, interconnect patterns in a semiconductor device are becoming finer and finer. With the progress toward finer interconnect patterns, materials used for interconnects are changing from conventional aluminum and aluminum alloys to copper and copper alloys. The resistivity of copper is 1.67 μΩcm, which is about 37% lower than the resistivity (2.65 μΩcm) of aluminum. Therefore, compared to aluminum interconnects, copper interconnects can not only reduce power consumption, but can also be made finer with the same interconnect resistance. In addition, because of the lower resistance, copper interconnects have the advantage of reduced signal delay.

Filling of copper into trenches, holes, or resist openings formed in a surface of a semiconductor substrate is generally performed by electroplating which can form a film faster than PVC or CVD. In the electroplating, a voltage is applied between a substrate and an anode in the presence of a plating solution to deposit a copper film on a low-resistance seed layer (or a feeding layer) which has been formed in advance on the substrate. Such a seed layer is generally comprised of a thin copper film (copper seed layer) formed by, for example, PVD. Since there is a demand for a thinner seed layer with the progress toward finer interconnects, the thickness of the seed layer, which is generally of the order of 50 nm, is expected to decrease to not more than 10 nm to 20 nm in the future.

Further, in fields of semiconductor devices and print interconnects, there is a trend to use the electroplating technique for performing a so-called bottom-up plating which is to deposit metal preferentially on a bottom of a recess. Further, in order to meet the recent demand for a smaller circuit system using semiconductors, implementation of semiconductor circuits in a package having approximately the same size as a chip has come into practical use. A packaging method called wafer level package (WLP or WL-CSP) has been proposed as a method of performing implementation of semiconductor circuits in such a package (see, for example, “BACKGROUND” of Japanese Patent Laid-Open Publication No. 2012-60100, and “Development of Wafer-level Chip Size Package” issued on January 2007 by Furukawa Electric Co., Ltd).

The wafer level package is generally classified into fan-in technique (also called WLCSP (Wafer-Level Chip-Scale Package)) and fan-out technique. The fan-in WLP is a technique for providing external electrodes (external terminals) in a chip-size area. The fan-out WLP, on the other hand, is a technique for providing external terminals in an area larger than a chip, for example, forming a re-distribution layer and external electrodes on a substrate formed of an insulating resin in which a plurality of chips are embedded. An electroplating technique is sometimes used for forming a re-distribution layer, an insulating layer, etc. on a wafer, and is expected to be applied also in the fan-out WLP. A higher level of technique, especially in control of a plating solution, is required in order to apply the electroplating technique in the fan-out WLP or the like for which finer pitches are strongly required.

With a view to performing so-called bottom-up plating, the applicant has proposed a method of plating a substrate, such as a wafer, while preventing a generation of an electrolyte component which inhibits bottom-up plating (see Japanese Patent Laid-Open Publication No. 2016-074975). This method involves bringing an insoluble anode and a substrate into contact with a copper sulfate plating solution containing additives, and applying a predetermined plating voltage from a plating power source to between the substrate and the insoluble anode to plate the substrate.

On the other hand, in order to replenish a plating solution with objective metal ions in a plating apparatus which uses an insoluble anode as described above, it is conceivable to use a method in which a powdery metal salt is fed into a circulation tank or a method in which metal pieces are dissolved in a separate tank for replenishment. When the powdery metal salt is supplied into a plating solution, fine particles increases in the plating solution and may cause a defect in a surface of a plated substrate. In view of this, the applicant has proposed a technique which can keep concentrations of components of a plating solution constant over a long period of time in a plating apparatus that uses an insoluble anode (see Japanese Patent Laid-Open Publication No. 2007-051362). This technique, which involves circulating and reusing a plating solution while recovering the plating solution, can minimize the amount of the plating solution used. Further, the use of an insoluble anode can eliminate the need for replacement of the anode, thereby facilitating maintenance and management of the anode. Furthermore, the concentration of a component(s) of the plating solution, which changes with the circulation and reuse of the plating solution, can be maintained within a certain range by supplying a replenishing solution, containing the plating solution component(s) at a concentration high than the plating solution, to the plating solution.

As copper plating of substrates is performed, copper ions in the plating solution decrease. Therefore, it is necessary for a plating-solution supply device to adjust the concentration of the copper ions in the plating solution. One solution to replenish the plating solution with copper is to add copper oxide powder to the plating solution. However, the copper oxide powder contains a small amount of impurities therein. As a result, even if the solution is managed as in the Japanese Patent Laid-Open Publication No. 2007-051362, the impurities, together with the copper to be supplied, are added to the plating solution. If the concentration of the impurities is high, a quality of a copper film, deposited on a substrate by plating, is lowered.

### SUMMARY OF THE INVENTION

Thus, according to one embodiment, there is provided a soluble copper oxide powder capable of preventing a decrease in quality of a copper film formed by plating. Further, according to one embodiment, there are provided a method of plating a substrate with use of such copper oxide powder, and a method of managing a plating solution with use of such copper oxide powder.

Embodiments, which will be described below, relate to copper oxide powder to be fed into a plating solution, and more particularly to copper oxide powder for use in plating of a substrate using an insoluble anode. Further, embodiments, which will be described below, relate to a method of plating a substrate with use of such copper oxide powder, and a method of managing a plating solution with use of such copper oxide powder.

The inventors of the present invention have found from experiments the fact that, among impurities contained in the copper oxide powder, a high concentration of sodium (Na) causes a decrease in quality of a copper film formed on a substrate. The possible cause of this is an adverse influence of sodium on additives (suppressor, accelerator, leveler, etc.) contained in the plating solution. The above-discussed problem does not occur in plating of a substrate using a soluble anode. This is considered to be due to the fact that the soluble anode does not contain sodium. In contrast, in plating of a substrate using an insoluble anode, it is necessary to feed the copper oxide powder into the plating solution regularly.

In an embodiment, there is provided a copper oxide powder to be supplied into a plating solution for plating a substrate, comprising: copper; and impurities including sodium, a concentration of the sodium being not more than 20 ppm.

In an embodiment, a total of concentrations of the impurities is not more than 50 ppm.

In an embodiment, the impurities include iron at a concentration of less than 10 ppm, the sodium at a concentration of less than 20 ppm, calcium at a concentration of less than 5 ppm, zinc at a concentration of less than 20 ppm, nickel at a concentration of less than 5 ppm, chromium at a concentration of less than 5 ppm, arsenic at a concentration of less than 5 ppm, lead at a concentration of less than 5 ppm, chlorine at a concentration of less than 10 ppm, and silver at a concentration of less than 5 ppm.

In an embodiment, a particle size of the copper oxide powder is in a range of 10 micrometers to 200 micrometers.

In an embodiment, there is provided a method of plating a substrate, comprising: supplying copper oxide powder into a plating solution, the copper oxide powder containing copper and impurities including sodium, a concentration of the sodium being not more than 20 ppm; and applying a voltage between an insoluble anode and a substrate immersed in the plating solution to plate the substrate.

In an embodiment, a total of concentrations of the impurities is not more than 50 ppm.

In an embodiment, there is provided a method of managing a plating solution for use in a plating apparatus having an insoluble anode, comprising: supplying copper oxide powder into a plating solution such that a copper ion concentration in the plating solution held in a plating tank is kept within a predetermined management range, the copper oxide powder containing copper and impurities including sodium, a concentration of the sodium being not more than 20 ppm.

In an embodiment, a total of concentrations of the impurities is not more than 50 ppm.

In an embodiment, supplying of the copper oxide powder into the plating solution comprising supplying the copper oxide powder into the plating solution held in a plating-solution tank and dissolving the copper oxide powder in the plating solution while circulating the plating solution between the plating tank and the plating-solution tank.

According to the embodiments described above, the quality of a copper film deposited on a substrate, such as wafer, can be improved.

### BRIEF DESCRIPTION OF THE DRAWINGS

FIG. 1 is a schematic view showing an embodiment of a plating system; and

FIG. 2 is a graph showing a change in concentration of copper ions and a change in concentration of sodium contained in a plating solution during plating of a plurality of substrates.

### DESCRIPTION OF EMBODIMENTS

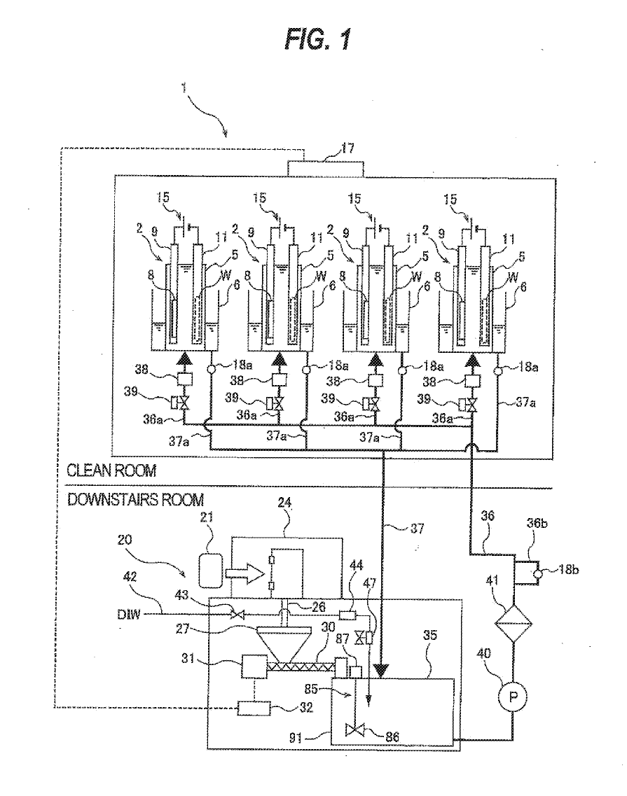

Embodiments will now be described with reference to the drawings. FIG. 1 is a schematic overall view of a plating system according to an embodiment. The plating system includes a plating apparatus 1 installed in a clean room, and a plating-solution supply apparatus 20 installed in a downstairs room. In this embodiment, the plating apparatus 1 is an electroplating unit for electroplating a substrate (e.g., a wafer) with copper, and the plating-solution supply apparatus 20 is a plating-solution supply unit for supplying copper oxide powder into a plating solution to be used in the plating apparatus 1.

In this embodiment, an average particle size of the copper oxide powder is in the range of 10 micrometers to 200 micrometers, preferably in the range of 20 micrometers to 100 micrometers, more preferably in the range of 30 micrometers to 50 micrometers. If the average particle size is too small, the powder is likely to scatter as dust. On the other hand, if the average particle size is too large, the solubility of the powder, when fed into a plating solution, may be poor.

The plating apparatus 1 has four plating tanks 2. Each plating tank 2 includes an inner tank 5 and an outer tank 6. An insoluble anode 8, held by an anode holder 9, is disposed in the inner tank 5. Further, in the plating tank 2, a neutral membrane (not shown) is disposed around the insoluble anode 8. The inner tank 5 is filled with a plating solution, which is allowed to overflow the inner tank 5 into the outer tank 6. The inner tank 5 is also provided with an agitation paddle (not shown) comprised of a rectangular plate-like member having a constant thickness, made of a resin such as PVC, PP or PTFE, or a metal, such as stainless steel or titanium, coated with a fluororesin or the like. The agitation paddle reciprocates parallel to a substrate W to agitate the plating solution, so that sufficient copper ions and additives can be supplied uniformly to a surface of the substrate W.

The substrate W, such as a wafer, is held by a substrate holder 11 and is immersed, together with the substrate holder 11, in the plating solution held in the inner tank 5 of the plating tank 2. The substrate W, as an object to be plated, may be a semiconductor substrate, a printed circuit board, etc. In the case of using a semiconductor substrate as the substrate W, the semiconductor substrate is flat or substantially flat (a substrate having a groove(s), a tube(s), a resist pattern(s), etc. is herein regarded as substantially flat). When plating such a flat object, it is necessary to control a plating condition over time in consideration of the in-plane uniformity of a plating film formed on the substrate, while preventing a deterioration in the quality of the film.

The insoluble anode 8 is electrically connected via the anode holder 9 to a positive pole of a plating power source 15, while the substrate W held by the substrate holder 11 is electrically connected via the substrate holder 11 to a negative pole of the plating power source 15. When a voltage is applied from the plating power source 15 between the insoluble anode 8 and the substrate W that are both immersed in the plating solution, an electrochemical reaction occurs in the plating solution held in the plating tank 2, whereby copper is deposited on the surface of the substrate W. In this manner, the surface of the substrate W is plated with copper. The plating apparatus 1 may have less than four or more than four plating tanks 2.

The plating apparatus 1 includes a plating controller 17 for controlling the plating process of the substrate W. The plating controller 17 has a function of calculating a concentration of copper ions contained in the plating solution in each plating tank 2 from a cumulative value of electric current that has flowed in the substrate W. Copper in the plating solution is consumed as the substrate W is plated. The consumption of copper is proportional to the cumulative value of electric current that has flowed in the substrate W. The plating controller 17 can therefore calculate the copper ion concentration in the plating solution in each plating tank 2 from the cumulative value of electric current.

The plating-solution supply apparatus 20 includes an airtight chamber 24 into which a powder container 21, holding copper oxide powder therein, is to be carried, a hopper 27 for storing the copper oxide powder supplied from the powder container 21, a feeder 30 which communicates with a bottom opening of the hopper 27, a motor 31 coupled to the feeder 30, a plating-solution tank 35 coupled to an outlet of the feeder 30 and configured to dissolve the copper oxide powder in a plating solution, and an operation controller 32 for controlling the operation of the motor 31. The feeder 30 is actuated by them motor 31.

The powder container 21, holding the copper oxide powder therein, is carried into the airtight chamber 24. The powder container 21 is then coupled to an inlet 26 of the hopper 27. When a valve (not shown) of the powder container 21 is opened in the airtight chamber 24, the copper oxide powder is supplied into the hopper 27, and is stored in the hopper 27. In order to prevent diffusion of the copper oxide powder, a negative pressure is produced in the airtight chamber 24.

An acidic copper sulfate plating solution containing sulfuric acid, copper sulfate, halogen ions, and organic additives, in particular a plating accelerator e.g. comprising SPS (bis(3-sulfopropyl) disulfide), a suppressor e.g. comprising PEG (polyethylene glycol) and a leveler e.g. comprising PEI (polyethylenimine), may be used as the plating solution. Chloride ions are preferably used as the halogen ions.

The plating apparatus 1 and the plating-solution supply apparatus 20 are coupled to each other by a plating-solution supply pipe 36 and a plating-solution return pipe 37. More specifically, the plating-solution supply pipe 36 extends from the plating-solution tank 35 to a bottom of the inner tank 5 of each plating tank 2. The plating-solution supply pipe 36 is divided into four branch pipes 36a, which are coupled to the bottoms of the inner tanks 5 of the four plating tanks 2, respectively. The four branch pipes 36a are provided with respective flow meters 38 and respective flow control valves 39. The flow meters 38 and the flow control valves 39 are coupled to the plating controller 17. The plating controller 17 is configured to control a degree of opening of each flow control valve 39 based on a flow rate of the plating solution measured by the flow meter 38. Therefore, the flow rates of the plating solutions supplied to the plating tanks 2 through the four branch pipes 36a are regulated by the flow control valves 39, provided upstream of the plating tanks 2, so that the flow rates are kept substantially the same. The plating-solution return pipe 37 extends from the bottom of the outer tank 6 of each plating tank 2 to the plating-solution tank 35. The plating-solution return pipe 37 has four discharge pipes 37a coupled to the bottoms of the outer tanks 6 of the four plating tanks 2, respectively.

The plating-solution supply pipe 36 is provided with a pump 40 for delivering the plating solution, and a filter 41 disposed downstream of the pump 40. The plating solution that was been used in the plating apparatus 1 is delivered through the plating-solution return pipe 37 to the plating-solution supply apparatus 20. The plating solution to which the copper oxide powder has been added in the plating-solution supply apparatus 20 is fed through the plating-solution supply pipe 36 to the plating apparatus 1. The pump 40 may continually circulate the plating solution between the plating apparatus 1 and the plating-solution supply apparatus 20, or may intermittently deliver a predetermined amount of the plating solution from the plating apparatus 1 to the plating-solution supply apparatus 20, and may intermittently return the plating solution, to which the copper oxide powder has been added, from the plating-solution supply apparatus 20 to the plating apparatus 1.

In order to replenish the plating solution with pure water (DIW), a pure-water supply line 42 is coupled to the plating-solution tank 35. This pure-water supply line 42 is provided with an on-off valve 43 (which is usually open) for stopping the supply of pure water when the operation of the plating apparatus 1 is stopped, a flow meter 44 for measuring a flow rate of the pure water, and a flow control valve 47 for controlling a flow rate of the pure water. The flow meter 44 and the flow control valve 47 are coupled to the plating controller 17. The plating controller 17 is configured to control a degree of opening of the flow control valve 47 to supply the pure water into the plating-solution tank 35 in order to dilute the plating solution when the copper ion concentration in the plating solution has exceeded an upper limit of a predetermined management range.

The plating controller 17 is coupled to the operation controller 32 of the plating-solution supply apparatus 20. The plating controller 17 is configured to send a signal indicating a replenishment demand value to the operation controller 32 of the plating-solution supply apparatus 20 when the copper ion concentration in the plating solution has become lower than a lower limit of the predetermined management range. Upon receipt of the signal, the plating-solution supply apparatus 20 adds the copper oxide powder to the plating solution until the amount of the added copper oxide powder reaches the replenishment demand value. More specifically, the operation controller 32 instructs the motor 31 to drive the feeder 30. The copper oxide powder in the hopper 27 is delivered into the plating-solution tank 35 by the feeder 30.

The plating-solution tank 35 includes an agitation device 85, and an agitation tank 91 in which the agitation device 85 is disposed. The agitation device 85 has agitation paddles 86 located in the agitation tank 91, and a motor 87 coupled to the agitation paddles 86. The motor 87 is configured to rotate the agitation paddles 86 so as to dissolve the copper oxide powder in the plating solution. The operation of the agitation device 85 is controlled by the above-described operation controller 32.

Although in this embodiment the plating controller 17 and the operation controller 32 are constructed as separate devices, in one embodiment the plating controller 17 and the operation controller 32 may be constructed as one controller. In that case, the controller may be a computer that operates in accordance with a program. The program may be stored in a non-transitory storage medium.

The plating apparatus 1 may include concentration measuring devices 18a each for for measuring the copper ion concentration in the plating solution. The concentration measuring devices 18a are attached to the four discharge pipes 37a of the plating-solution return pipe 37, respectively. A measured value of the copper ion concentration obtained by each concentration measuring device 18a is sent to the plating controller 17. The plating controller 17 may compare the lower limit of the above-described management range with a copper ion concentration in the plating solution calculated from the cumulative value of electric current as discussed previously, or may compare the lower limit of the above-described management range with a copper ion concentration measured by the concentration measuring device(s) 18a. The plating controller 17 may correct the calculated value of the copper ion concentration based on a comparison of a copper ion concentration in the plating solution, calculated from the cumulative value of electric current (i.e., calculated value of the copper ion concentration), with a copper ion concentration measured by the concentration measuring device(s) 18a (i.e. measured value of the copper ion concentration). For example, the plating controller 17 may determine a correction factor by dividing a measured value of the copper ion concentration by a calculated value of the copper ion concentration, and correct a calculated value of the copper ion concentration by multiplying the calculated value by the correction factor. The correction factor may preferably be updated periodically.

The plating-solution supply pipe 36 may have a branch pipe 36b, which is provided with a concentration measuring device 18b to monitor the copper ion concentration in the plating solution. The branch pipe 36b may be further provided with an analyzer(s) (e.g. a CVS device or a colorimeter) to perform quantitative analysis and monitoring of the concentration of a dissolved chemical component(s) in addition to the copper ion. Such a construction makes it possible to analyze the concentration of the chemical component, e.g. an impurity, in the plating solution existing in the plating-solution supply pipe 36 before the plating solution is supplied to the plating tanks 2. This can prevent the dissolved impurity from affecting the plating performance and can more ensure highly-precise plating. Only one of the concentration measuring devices 18a, 18b may be provided.

With the above-described construction, the plating system according to the embodiment can replenish the plating solution with copper while keeping the copper ion concentration in the plating solution substantially equal among the plating tanks 2. The plating tanks 2 may be in fluid communication with each other through liquid circulation passages (not shown) so that concentrations of components in the plating solution are substantially equal among the plating tanks 2.

As a plurality of substrates W are plated in the plating apparatus 1 using the insoluble anode 8, the copper ion concentration in the plating solution is gradually lowered. Thus, the copper oxide powder is regularly supplied into the plating solution, so that the copper ion concentration in the plating solution held in the plating tanks 2 is maintained within the predetermined management range. The copper oxide powder serves as a source of copper ions for the plating solution.

However, the copper oxide powder contains a slight amount of impurities, such as sodium, therein due to production processes of the copper oxide powder. These impurities accumulate in the plating solution each time the copper oxide powder is fed into the plating solution. If the concentration of the impurities increases to some extent, the quality of the copper film formed on the substrate W in the plating tank 2 is lowered. For example, the surface of the copper film is roughened, or the impurities are absorbed in the copper film, thus causing a change in property of the copper film. In order to avoid such a decrease in the quality of the copper film, in this embodiment, the total of concentrations of the impurities contained in the copper oxide powder to be added to the plating solution is not more than 50 ppm.

The inventors of the present invention have found from experiments the fact that, among the impurities contained in the copper oxide powder, a high concentration of sodium (Na) causes the decrease in quality of the copper film formed on the substrate. The possible cause of this is an adverse influence of sodium on additives (suppressor, accelerator, leveler, etc.) contained in the plating solution. The above-discussed problem does not occur in plating of a substrate using a soluble anode. This is considered to be due to the fact that the soluble anode does not contain sodium. In contrast, in plating of a substrate using the insoluble anode, it is necessary to feed the copper oxide powder into the plating solution regularly.

The present inventors have found through the experiments that using the copper oxide powder containing a concentration of not more than 20 ppm of sodium (Na) does not cause the decrease in the quality of the copper film even after a plurality of substrates have been plated with copper in an amount corresponding to 1 turn. The 1 turn is a period of time from when a plating bath is made up to when copper in all of the plating solution existing in the plating system is consumed as a result of plating of substrates. The amount of copper corresponding to 1 turn is a total amount of copper contained in all of the plating solution existing in the plating system at the time of make-up of the plating bath. The “turn” is also referred to as metal turnover.

In this embodiment, the copper oxide powder containing a concentration of 20 ppm of sodium (Na) is used. In one embodiment, a concentration of copper (Cu) in the copper oxide powder is not less than 70 percent by weight. Allowable impurities contained in the copper oxide powder include Fe (iron) at a concentration of less than 10 ppm, Na (sodium) at a concentration of less than 20 ppm, Ca (calcium) at a concentration of less than 5 ppm, Zn (zinc) at a concentration of less than 20 ppm, Ni (nickel) at a concentration of less than 5 ppm, Cr (chromium) at a concentration of less than 5 ppm. As (arsenic) at a concentration of less than 5 ppm, Pb (lead) at a concentration of less than 5 ppm, Cl (chlorine) at a concentration of less than 10 ppm, and Ag (silver) at a concentration of less than 5 ppm.

Techniques of analyzing the impurities in the copper oxide powder include an electron probe micro analyzer (EPMA) and X-ray fluorescence analyzer (XRF), both of which being capable of analyzing a specimen in a solid state, and inductively coupled plasma atomic emission spectroscopy (ICP-AES) for analyzing a dissolved powder in water.

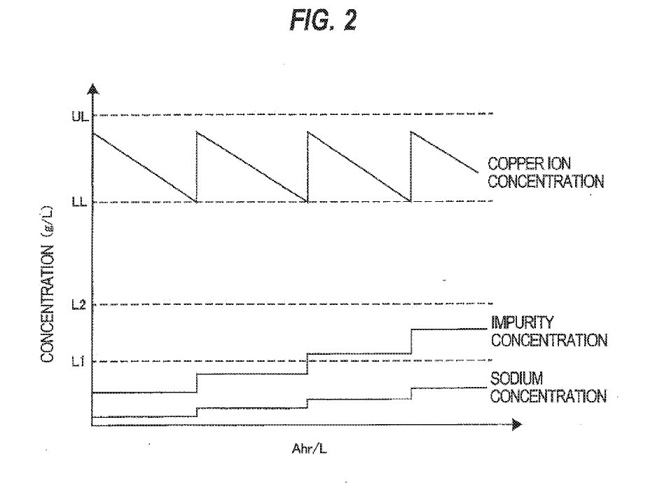

FIG. 2 is a graph showing a change in copper ion concentration and a change in sodium concentration in a plating solution during plating of a plurality of substrates. Vertical axis represents concentration, and horizontal axis represents amount of electrolysis per 1 L of the plating solution, i.e., ampere hour per liter. A symbol UL shown in FIG. 2 represents the upper limit of the management range of the copper ion concentration in the plating solution, and a symbol LL represents the lower limit of the management range. As a plurality of substrates are plated, the copper ion concentration in the plating solution is gradually lowered. When the copper ion concentration is reduced to the lower limit LL of the management range, the copper oxide powder is supplied into the plating solution. An amount of the copper oxide powder to be supplied is calculated by the plating controller 17.

In this embodiment in which the copper oxide powder is regularly supplied into the plating solution, it may be preferable to supply the copper oxide powder into the copper oxide powder such that an amount of copper corresponding to 1.5 turns is consumed until the next plating bath is made up.

The impurities, such as sodium, accumulate in the plating solution each time the copper oxide powder is fed into the plating solution. According to the embodiment, since the concentration of sodium contained in the copper oxide powder is not more than 20 ppm, the concentration of sodium in the plating solution does not reach a predetermined sodium-concentration upper limit L1 until the next plating bath is made up, even if the copper oxide powder is supplied into the plating solution several times. Moreover, since the total of the concentrations of the impurities (including sodium) contained in the copper oxide powder is not more than 50 ppm, the concentration of the impurities in the plating solution also does not reach a predetermined impurity-concentration upper limit L2. In other words, the concentration of sodium and the total of the concentrations of the entire impurities (including sodium) contained in the copper oxide powder are determined such that the concentration of sodium and the total of the concentrations of the entire impurities in the plating solution are less than the respective upper limits L1, L2 when a plurality of substrates are plated until a desired amount of electrolysis (or a desired amount of plating) is reached.

The concentration of sodium and the concentrations of impurities, including sodium, contained in the copper oxide powder can be controlled by a known technique. For example, the following technique can be employed ire manufacturing of copper oxide powder for use in plating. An aqueous solution containing copper sulfate, and an aqueous solution containing carbonate of NH₄ are mixed with each other, while these aqueous solutions are being heated, thereby producing basic copper carbonate. Subsequently, the basic copper carbonate is heated to have a temperature in a range of 200° C. to 700° C. under a non-reducing atmosphere. As a result, the basic copper carbonate is pyrolyzed, thus producing soluble copper oxide. Further, the soluble copper oxide is cleaned with water. In this water-cleaning, by adjusting a water-cleaning time and adjusting an agitating intensity of the water-cleaning, the concentration of sodium and the concentrations of the impurities, including the sodium, contained in the copper oxide powder can be controlled.

According to the above-discussed embodiment using the copper oxide powder containing sodium at a concentration of not more than 20 ppm, the copper ion concentration in the plating solution held in the plating tanks 2 can fall within the management range, and the concentration of sodium in the plating solution can be kept low during 1 to 1.5 turns. Therefore, it is possible to prevent the decrease in quality of the copper film formed on the plated substrate.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A copper oxide powder to be supplied into a plating solution for plating a substrate, comprising:
copper; and
impurities including sodium, a concentration of the sodium being not more than 20 ppm.

2. The copper oxide powder according to claim 1, wherein a total of concentrations of the impurities is not more than 50 ppm.

3. The copper oxide powder according to claim 2, wherein the impurities include iron at a concentration of less than 10 ppm, the sodium at a concentration of less than 20 ppm, calcium at a concentration of less than 5 ppm, zinc at a concentration of less than 20 ppm, nickel at a concentration of less than 5 ppm, chromium at a concentration of less than 5 ppm, arsenic at a concentration of less than 5 ppm, lead at a concentration of less than 5 ppm, chlorine at a concentration of less than 10 ppm, and silver at a concentration of less than 5 ppm.

4. The copper oxide powder according to claim 1, wherein a particle size of the copper oxide powder is in a range of 10 micrometers to 200 micrometers.

5. A method of plating a substrate, comprising:
supplying copper oxide powder into a plating solution, the copper oxide powder containing copper and impurities including sodium, a concentration of the sodium being not more than 20 ppm; and
applying a voltage between an insoluble anode and a substrate immersed in the plating solution to plate the substrate.

6. The method according to claim 5, wherein a total of concentrations of the impurities is not more than 50 ppm.

7. A method of managing a plating solution for use in a plating apparatus having an insoluble anode, comprising:
supplying copper oxide powder into a plating solution such that a copper ion concentration in the plating solution held in a plating tank is kept within a predetermined management range, the copper oxide powder containing copper and impurities including sodium, a concentration of the sodium being not more than 20 ppm.

8. The method according 7, wherein a total of concentrations of the impurities is not more than 50 ppm.

9. The method according to claim 7, wherein supplying of the copper oxide powder into the plating solution comprising supplying the copper oxide powder into the plating solution held in a plating-solution tank and dissolving the copper oxide powder in the plating solution while circulating the plating solution between the plating tank and the plating-solution tank.
